(19) United States
(12) Patent Application Publication
(10) Pub. No.: US 2001/0044329 A1
(43) Pub. Date: Nov. 22, 2001

(54) Handsfree cellular phone in neckroll enclosure

(76) Inventor: Gil Newsom, Asheboro, NC (US)

Correspondence Address: Richard C. Litman, LITMAN LAW OFFICES, LTD., P.O. Box 15035, Arlington, VA, 22215, US

(21) Appl. No.: 09/855,679

(22) Filed: May 16, 2001

Related U.S. Application Data
(60) Provisional application No. 60/204,752, filed on May 17, 2000.

(51) Int. Cl. H04M 1/00

(52) U.S. Cl. 455/569; 455/557; 455/90; 379/430

(57) ABSTRACT

A detachable neckroll that attaches to the headrest of an automobile seat and that allows hands free use of a cellular or mobile telephone while a person is driving. The neckroll is formed from a cushioned body attachable to the headrest of an automobile seat by a strap having hook and loop fastening material. The neckroll houses at least one speaker and supports a pivotally mounted boom microphone which may be positioned in front of an occupant of the automobile seat. A cord with a phone plug attaches the neckroll to a cellular phone. The cord may include an inline volume control for adjusting the volume of the speaker and/or microphone. The contoured neckroll allows the user to converse over the telephone while remaining alert and attentive to his or her driving.

### CROSS-REFERENCE TO RELATED APPLICATION

This application claims the benefit of U.S. Provisional Patent Application Ser. No. 60/204,752, filed May 17, 2000.

### BACKGROUND OF THE INVENTION

1. Field of the Invention

The present invention relates generally to cellular phone accessories and more particularly, to a neckroll that fits over the headrest of a car seat. The neckroll has a microphone and speaker that allow the driver of the car hands-free operation of a cellular phone inside the car.

2. Description of Related Art

The growth and popularity of wireless and mobile cellular communication has been phenomenal. Cell phones are very prevalent and their use is expected to continue its rapid growth. People often use cell phones while driving. However, using a cell phone while driving a motor vehicle can be extremely dangerous because the driver is not paying full attention to the road, since the driver is forced to hold the cell phone in one hand, leaving the driver with only one hand to steer the car. So-called hands free cell phone accessories do free both hands of a driver for driving. However, these accessories are frequently awkward and inconvenient to use.

The prior art describes a variety of automobile seat headrest arrangements for mobile communication. For example, a speaker equipped headrest is described in U.S. Pat. No. 4,758,047, issued on Jul. 19, 1988 to J. K. Hennington. The headrest is attachable to a vehicle seat structure and includes one or more speakers located at the ends of the headrest. A main base member of the headrest receives the speakers in recessed areas while a headrest cover encloses the speakers and main body.

U.S. Pat. No. 5,613,222, issued on Mar. 18, 1997 to D. E. Guenther, describes a cellular telephone headset for hands-free communication. The headset comprises an acoustical earpiece assembly adapted for the acoustical transmission of sound to the ear, a device for mounting the earpiece assembly on the head in a position adjacent an ear of a person wearing the headset, and a flexible acoustical receiving tube having an upper end connected to the earpiece assembly and a lower end attached to an acoustical receiving cup.

A device for mobile telephones is described in U.S. Pat. No. 5,687,230, issued on Nov. 11, 1997 to J. Olausson, et al. The device for a mobile telephone apparatus has a loudspeaker and a microphone arranged in connection with a headrest. The loudspeaker and the microphone are connected to the mobile telephone apparatus. The headrest is adapted to be removably arranged on a vehicle seat. The loudspeaker is integrated within the headrest and the microphone is arranged on an arm which is attached to the headrest.

None of the above inventions and patents, taken either singly or in combination, is seen to describe the instant invention as claimed.

### SUMMARY OF THE INVENTION

The present invention provides a hands-free cellular phone neckroll attachment that allows the driver of a motor vehicle hands-free operation of a cellular or mobile telephone while driving the vehicle. The detachable neckroll allows a driver to have a telephone conversation while remaining alert and focused on his or her driving. The neckroll has a micro-recorder that can be activated by a driver to record dictation for playback at a later time, which eliminates the need for pen and paper while driving.

The neckroll is convenient and easy to use. Simply wrap the strap of the neckroll around the headrest of an automobile seat and plug the electrical connector of the electrical cord of the neckroll into the cellular phone. The retractable, flexible microphone is pulled out from the neckroll unit and bent close to the mouth of the driver. The volume control unit of the neckroll has conveniently located volume control buttons along with record and play buttons which allows for fingertip control of sound adjustments and recording. The easily accessible record and playback buttons make dictating notes simple and straightforward.

The body of the neckroll has a soft fabric exterior, a foam cushioned middle, and a rectangular shaped interior housing that contains the functional electronic components and circuitry. The neckroll supports the head and neck with the soft cushioned portion of the neckroll enhancing comfort and improving posture. The user simply relaxes against the soft support of the neckroll in comfort while he or she speaks and listens.

The neckroll houses a PC circuit board that contains the electronic components needed to achieve the desired functions, for example, electronic components for signal amplification, electronic components for volume control, electronic components for voice recording, etc. The neckroll can incorporate the electronics needed to carry out any required function. Therefore, the neckroll can be interfaced with or connected to a wide range of electronic devices, for example, any type of cellular device; personal computers, such as laptops and palm held computers; or any type of external sound device.

Accordingly, it is a principal object of the invention to provide a hands-free cellular phone neckroll attachment that is comfortable and convenient to use.

It is another object of the invention to provide a detachable neckroll that helps the driver of a motor vehicle maintain the proper posture while driving which minimizes the effects of fatigue.

It is a further object of the invention to provide a detachable neckroll that allows the driver of a motor vehicle to converse over a cellular telephone while driving without becoming distracted from his or her driving.

Still another object of the invention is to provide a detachable neckroll that allows the driver of a motor vehicle to have two hands on the vehicle's steering wheel while talking over a cellular telephone.

It is an object of the invention to provide improved elements and arrangements thereof in a hands-free cellular phone neckroll attachment for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a person in a vehicle using the hands-free cellular phone neckroll according to the present invention.

FIG. 2 is a perspective view of the front portion of the hands-free cellular phone neckroll.

FIG. 3 is a perspective view of the rear portion of the hands-free cellular phone neckroll.

Similar reference characters denote corresponding features consistently throughout the attached drawings.

### DETAILED DESCRIPTION OF THE PREFERRED EMBODIMENTS

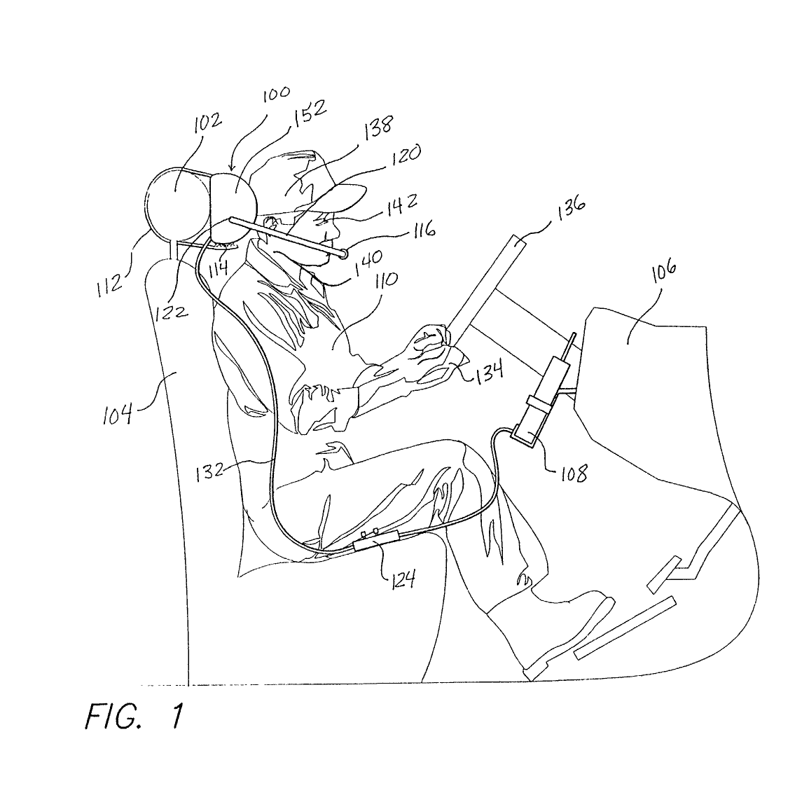

The present invention, as depicted in FIGS. 1-3, is a neckroll enclosure 100 that attaches to the headrest 102 of a car seat 104 (in this case, the driver's seat, although the neckroll may be attached to a passenger's car seat, if desired) in a motor vehicle 106 and which allows the driver 110 hands-free use of any type of cellular or mobile telephone 108. The neckroll 100 has an outer vinyl, fabric, or leather exterior that covers an underlying form cushion (hidden) which, in turn, encases a rectangular shape box (hidden) that houses a printed circuit board (hidden) which contains the necessary electronics for signal amplification and volume control and a power supply such as batteries for the proper operation of the microphone 116 and loudspeaker 118. In a preferred embodiment, the exterior of the neckroll 100 is made of a soft fabric material.

The neckroll 100 incorporates a micro-recorder for hands-free recording such as dictation. A record button (not shown) and a play button (not shown) disposed on the volume control box 124 are used to operate the micro-recorder. The micro-recorder employs an integrated circuit chip (not shown) that allows electronic voice recording and playback.

FIG. 1 is an environmental, perspective view of a person 110 driving a vehicle 106 while using the hands-free cellular phone neckroll 100 to talk on a cellular phone 108. The neckroll 100 allows the driver 100 to keep both hands 134 on the steering wheel 136 and his eyes focused on the road while carrying on a conversation over the cellular phone 108. The conveniently located volume control box 124 allows the driver 110 to readily adjust the volume of the microphone 116 or the volume of the speaker 118 to a comfortable level. The soft but firm foam cushioning of the neckroll gently and comfortably supports the driver's head 138 and neck 140 and helps the driver 110 maintain the proper posture while driving. This improved posture increases the driver's alertness and results in a significant reduction in stress because the driver 110 is more attentive to the road and therefore, less anxious.

As is depicted in FIG. 1, the microphone 116 is conveniently disposed in front of the driver's mouth (hidden), therefore, no lateral movement of the driver's head 138 is required for the driver 110 to speak into the microphone 116. The flexible, retractable microphone 116 is simply pulled out from the unit 100 and bent close to the mouth of the user 110. Thus, the driver's gaze remains on the road and the driver's eyes are never diverted in an attempt to locate the microphone 116. The strap portion 112 of the neckroll 100 conveniently wraps around the headrest 102 of the car seat 104. The neckroll 100 is secured around the headrest 102 using a hook and loop fastener 114 such as VELCRO. There is enough play in the neckroll 100 and headrest 102 engagement to allow the neckroll 100 to be either slightly raised or slightly lowered.

The neckroll 100 is electrically connected to the cellular phone 108 by means of an electrical cord 132 that connects directly to the neckroll 100 at one end 148 and that has an electrical connector or phone plug 130 on the opposite end 150 that connects directly to the cellular phone 108. A speaker and microphone volume control box 124 is disposed inline between the two ends 148,150 of the electrical cord 132.

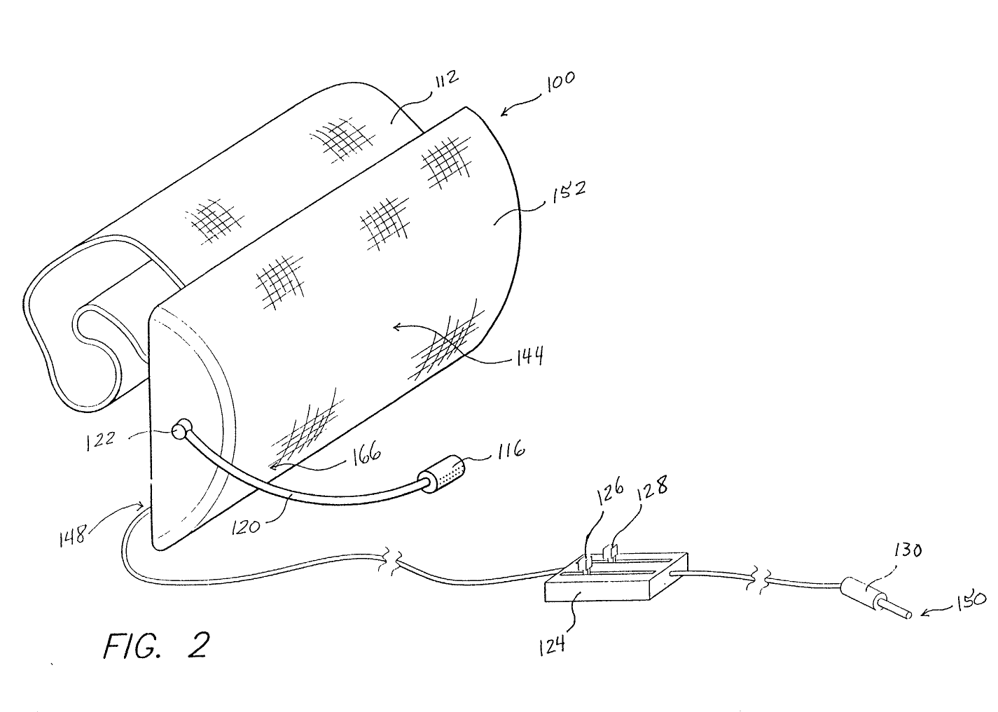

FIG. 2 is a perspective view of the front portion 144 of the hands-free cellular phone neckroll 100 showing convex contour of the neckroll 100. The microphone 116 is designed to pivot up and down around the point 122 at which the microphone arm 120 is attached to the body 152 of the neckroll 100. Therefore, when the microphone arm 120 is in the upright position (not shown), the microphone 116 is disposed behind the driver 110 and when the microphone arm 120 is in the lowered position, as depicted in FIG. 1, the microphone 116 is conveniently disposed directly in front of the driver's mouth. The volume control box 124 has a separate control or button, such as slider 126, for adjusting the volume of the microphone 116 and a separate control or button, such as slider 128, for adjusting the volume of the speaker 118.

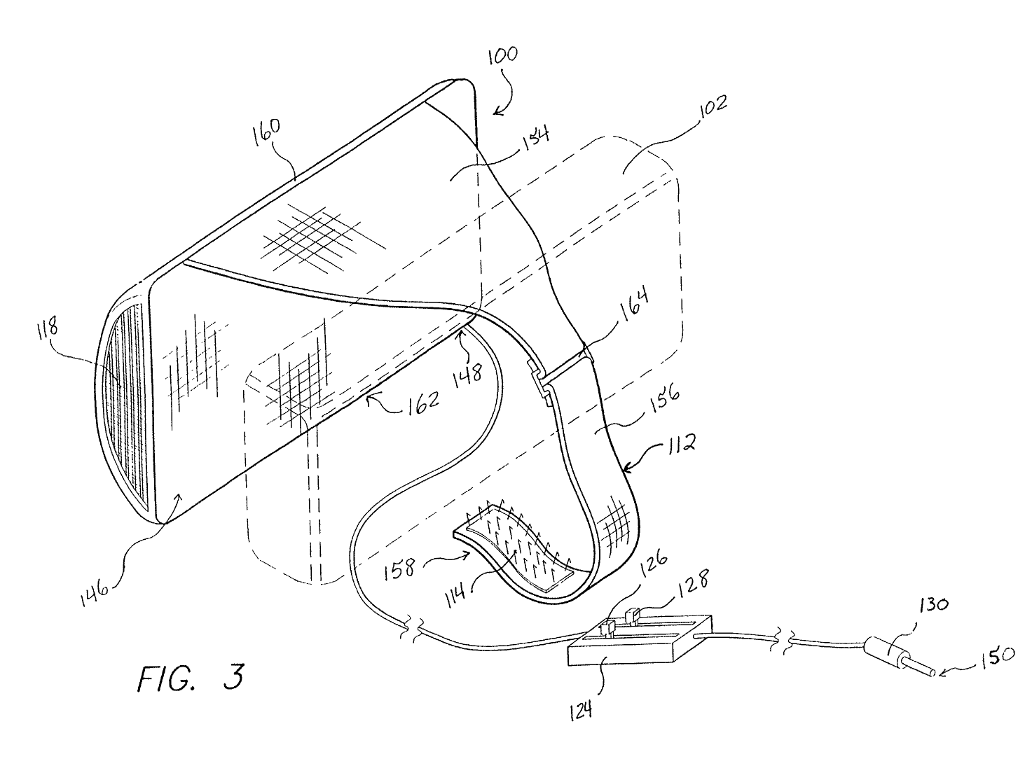

FIG. 3 is a perspective view of the rear portion 146 of the hands-free cellular phone neckroll 100. The securing strap 112 has a wide portion 154 that connects directly to the rear upper edge 160 of the body portion 152 of the neckroll 100 with the strap 112 tapering to a narrower width free end 156 that has a fastening material 158. The free end fastening material 158 adheres to a mating surface of fastening material (hidden) medially disposed on the lower surface 162 of the neckroll body 152. The length of the strap 112 can be increased or decreased to accommodate the size of headrest 102. The length of the strap 112 is changed using a length adjustment means, such as buckle 164.

In an alternate embodiment, the neckroll 100 has a pair of lateral disposed speakers (not shown) and the pivot point of the microphone arm 120 is disposed on the lower lateral portion 166 of the neckroll body 152. In the alternate embodiment, the neckroll 100 can be electrically connected to the CD player in a car or to the car radio. The dual speakers provide a stereo sound for the listener 110.

The neckroll 100 can also have a pair of electrical connectors disposed at the free end of the electrical cord (not shown). One connector is connected to the cellular phone 108 and the other connector is connected to the car's cigarette lighter (not shown), which recharges the cellular phone 108. The cellular phone 108 can be used while recharging. The neckroll 100 can be used with a variety of electrical cords 132 and electrical connectors 130 to accommodate a wide range of car accessories such as CD players, tape players, and recording equipment.

The novel and innovative hands-free cellular phone neckroll of the present invention allows for safer driving when using a cellular phone. The neckroll of the present invention can incorporate the electronic components and circuitry conventionally used to implement a specified function, interface, or task. The hands-free cellular phone neckroll is versatile allowing a car's cigarette lighter to be used as an alternative power supply for the neckroll's electronics instead of batteries. An ancillary ear bud plug for making conversations confidential can be used when desired.

The preferred embodiments of the present invention disclosed herein are intended to be illustrative only and are not intended to limit the scope of the invention. It should be understood by those skilled in the art that various modifications and adaptations of the present invention as well as alternative embodiments of the present invention may be contemplated.

It is to be understood that the present invention is not limited to the embodiments described above, but encompasses any and all embodiments within the scope of the following claims.

I claim:

1. A detachable neckroll in combination with a cellular telephone comprising:
a cushioned body adapted for housing an electrical power supply and electrical circuitry;
means for attaching said cushioned body to a headrest of an automobile seat;
at least one speaker incorporated into said cushioned body;
at least one boom microphone pivotally attached to said cushioned body; and
an electrical cord connected to said cushioned body for electrically connecting said microphone and said speaker to said cellular telephone.

2. The detachable neckroll and cellular telephone according to claim 1, further comprising an inline volume control means for adjusting the volume of said speaker and said microphone, and disposed in said electrical cord, and electrically connected between said speaker, said microphone and the cellular telephone.

3. The detachable neckroll and cellular telephone according to claim 1, wherein said speaker is laterally disposed in an end of said neckroll.

4. The detachable neckroll and cellular telephone according to claim 1, wherein said means for attaching the neckroll to a headrest of an automobile seat comprises a strap having a first end integral with said cushioned, body and a second end having a strip of hook and loop fastening material attached thereto, said strap being adapted for wrapping around a headrest with the second end of said strap being removably fastened to said cushioned body.

5. A detachable neckroll for use with a cellular telephone comprising:
a cushioned body adapted for housing an electrical power supply and electrical circuitry;
at least one speaker incorporated into said cushioned body;
at least one boom microphone pivotally attached to said cushioned body; and
an electrical cord connected to said cushioned body for electrically connecting said microphone and said speaker to said cellular telephone.

6. The detachable neckroll according to claim 5, further comprising an inline volume control means for adjusting the volume of said speaker and said microphone, and disposed in said electrical cord, and electrically connected between said speaker, said microphone and the cellular telephone.

7. The detachable neckroll according to claim 1, wherein said speaker is laterally disposed in an end of said neckroll.

8. The detachable neckroll according to claim 5, further comprising means for attaching said neckroll to the headrest of an automobile seat.

9. The detachable neckroll according to claim 8, wherein said means for attaching the neckroll to a headrest of an automobile seat comprises a strap having a first end integral with said cushioned, body and a second end having a strip of hook and loop fastening material attached thereto, said strap being adapted for wrapping around a headrest with the second end of said strap being removably fastened to said cushioned body.

10. A detachable neckroll for use with a cellular telephone comprising:
a cushioned body adapted for housing an electrical power supply and electrical circuitry;
means for attaching said neckroll to the headrest of an automobile seat;
at least one speaker incorporated into said cushioned body, said speaker being laterally disposed in an end of said neckroll;
at least one boom microphone pivotally attached to said cushioned body;
an electrical cord connected to said cushioned body for electrically connecting said microphone and said speaker to said cellular telephone; and
an inline volume control means for adjusting the volume of said speaker and said microphone, and disposed in said electrical cord, and electrically connected between said speaker, said microphone and the cellular telephone.

11. The detachable neckroll according to claim 10, wherein said means for attaching the neckroll to a headrest of an automobile seat comprises a strap having a first end integral with said cushioned, body and a second end having a strip of hook and loop fastening material attached thereto, said strap being adapted for wrapping around a headrest with the second end of said strap being removably fastened to said cushioned body.
